(19) United States
(12) Patent Application Publication
(10) Pub. No.: US 2004/0254900 A1
(43) Pub. Date: Dec. 16, 2004

(54) Parking meter enforcement system

(76) Inventor: Sydney James Reinhard, Middle Cove NSW (AU)

Correspondence Address: WELSH & KATZ, LTD, 120 S RIVERSIDE PLAZA, 22ND FLOOR, CHICAGO, IL, 60606, US

(21) Appl. No.: 10/483,972

(22) PCT Filed: Jul. 5, 2002
(86) PCT No.: PCT/AU02/00883

(30) Foreign Application Priority Data
Jul. 16, 2001 (AU) PR 6413

(51) Int. Cl. G06F 17/60

(52) U.S. Cl. 705/418

(57) ABSTRACT

A parking citation (144) is disclosed, in relation to a vehicle (136) parked during a first time period in a parking space (108) associated with a parking meter (104), said citation comprising parking citation data (510) for the vehicle (136), and an automatically derived operational status (516) for the parking meter (104) during a time period in which a payment in respect of the first period could have been made, the operational status (516) on the citation (144) establishing whether the parking meter (104) was operative during the first time period. A method and a system for issuing the citation are also disclosed.

### TECHNICAL FIELD

The present invention relates generally to the field of parking meters, and in particular, to enforcement issues which arise in the administration of such systems. The present invention relates to a system and method for issuing a parking citation, as well as to a parking citation itself. The invention also relates to a computer program product including a computer readable medium having recorded thereon a program for issuing a parking citation.

### BACKGROUND

The constant increase in the number of motor vehicles flowing into cities around the world has forced city planners and authorities to find ways of rationing and controlling scarce on-street parking spaces. Typically, measures taken comprise use of parking meter systems, at which a motorist is able to pay an appropriate amount, for which in exchange, the motorist obtains a corresponding measure of time during which the motorists vehicle may remain parked in a designated parking spot.

In order to ensure that motorists adhere to the legislative requirements of time, price and parking restrictions, which are typically pre-defined in such parking meter systems, authorities usually implement an enforcement regime. Enforcement is typically legislatively supported, and is usually carried out by teams of authorised officers who inspect the parked vehicles, ensure that appropriate payment has been made, and ensure that the time that has been purchased by motorists has not been exceeded. Examples of the scope of the parking regulations considered by the officers include “No Parking”, “No standing”, “Sanitation”, “Paid parking becomes a clearway at 16:30” and so on. The intention of the enforcement regime is to ensure that there is a constant turnover of vehicles moving in and out of available parking spaces, so that businesses in the area may prosper, and so that motorists have an opportunity to carry out their business. There are also safety issues relating to blockage of areas such as fire hydrants or driveways that are enforced.

When payment is not made, or when the vehicle remains in the parking space longer than the time which has been purchased, or the vehicle is in violation of other parking restrictions as noted above, the enforcement agent, or officer, is typically legally empowered to take enforcement measures. In most modern cities, a parking ticket, or notice of violation (typically called called a “citation” or an “infringement”) is issued in the form of a ticket which often is generated by a hand-held computer used by the enforcement officer. It is noted that parking meters that are presently used are typically electronic devices.

In a large number of instances in which a citation has been issued, the affected motorist will contest the citation, on the basis that the citation was improperly given. One of the most commonly used reasons for requesting that a parking ticket be cancelled is that the parking meter was malfunctioning in some way at the relevant time when the motorist attempted to use the parking meter. This poses a considerable problem for the city authority, which typically has to prove that the meter was, in fact, working at the time of the parking infraction. In some instances, the legislative framework may require that the enforcement officer testify in court that the meter was in perfect working condition at the time of the infraction. This is typically extremely difficult, if not impossible, since the actual operational status of parking meters is generally difficult to ascertain, since this can only done by looking at historic service records, and determining that the meter should have been operational. Since parking fines are often issued for considerable amounts of money, and given that cities typically issue thousands of parking citations, a significant amount of revenue is at stake.

### SUMMARY OF THE INVENTION

It is an object of the present invention to substantially overcome, or at least ameliorate, one or more disadvantages of existing arrangements.

According to a first aspect of the invention, there is provided a method of issuing a parking citation against a vehicle that has been parked during a first time period in a parking space associated with a parking meter, said method comprising the steps of:

determining parking citation data for the vehicle;

automatically ascertaining an operational status for the parking meter during a second time period; and

issuing, depending upon the citation data and the operational status, the citation including the parking citation data and the operational status.

According to another aspect of the invention, there is provided a method of issuing a parking citation against a vehicle that has been parked during a first time period in a parking space associated with a parking meter, said method comprising the steps of:

determining parking citation data for the vehicle;

automatically ascertaining an operational status for the parking meter during a second time period;

issuing, depending upon the citation data and the operational status, the citation including the parking citation data; and

storing an associated electronic citation file comprising the parking citation data and the operational status.

According to another aspect of the invention, there is provided a parking meter system adapted for issuing a parking citation against a vehicle that has been parked during a first time period in a parking space associated with a parking meter, said system comprising:

means for establishing parking citation data for the vehicle;

means for automatically ascertaining an operational status for the parking meter during a second time period; and

means for issuing, depending upon the citation data and the operational status, the citation, said citation including the parking citation data and the operational status.

According to another aspect of the invention, there is provided a parking meter system adapted for issuing a parking citation against a vehicle that has been parked during a first time period in a parking space associated with a parking meter, said system comprising:

means for determining parking citation data for the vehicle;

means for automatically ascertaining an operational status for the parking meter during a second time period;

means for issuing, depending upon the citation data and the operational status, the citation, comprising the parking citation data; and

means for storing an associated electronic citation file comprising the parking citation data and the operational status, said electronic citation file serving as evidence that the parking meter was operative during the first time period.

According to another aspect of the invention, there is provided a parking citation for a vehicle parked during a first time period in a parking space associated with a parking meter, said citation comprising:

parking citation data for the vehicle; and

an automatically derived operational status for the parking meter during a time period in which a payment in respect of the first period could have been made, the operational status on the citation establishing whether the parking meter was operative during the first time period.

According to another aspect of the invention, there is provided a computer program comprising at least one program element, said at least one computer program element comprising computer program code means to make at least one computer execute a procedure to perform at least one of issuing and substantiating a parking meter citation, said at least one computer program element comprising:

code for a determining step for determining parking citation data for the vehicle;

code for an ascertaining step for automatically ascertaining an operational status for the parking meter during a second time period; and

code for an issuing step for issuing, depending upon the citation data and the operational status, a citation including the parking citation data and the operational status.

According to another aspect of the invention, there is provided a computer program comprising at least one program element, said at least one computer program element comprising computer program code means to make at least one computer execute a procedure to perform at least one of issuing and substantiating a parking meter citation, said at least one computer program element comprising:

code for a determining step for determining parking citation data for the vehicle;

code for an ascertaining step for automatically ascertaining an operational status for the parking meter during a second time period;

code for an issuing step for issuing, depending upon the citation data and the operational status, the citation, comprising the parking citation data; and

code for a storing step for storing an associated electronic citation file comprising the parking citation data and the operational status.

Other aspects of the invention are also disclosed.

One advantage of the methods or apparatus embodying the invention is that for the relevant authority, having access to the health or operational status decreases the likelihood of a motorist contesting a citation on the basis that the parking meter was inoperative.

### BRIEF DESCRIPTION OF THE DRAWINGS

One or more embodiments of the present invention will now be described with reference to the drawings, in which:

FIG. 1 is a system block diagram representation of one arrangement of a parking meter enforcement system;

FIG. 2 is a flow chart of steps taken by an enforcement officer in the context of the system of FIG. 1;

FIG. 3 depicts functional sub-systems within a parking meter and a portable terminal shown in FIG. 1;

FIG. 4 depicts functional sub-system blocks within the central system shown in FIG. 1;

FIG. 5 shows an exemplary health or operational status report, and citations which typically issue in the system of FIG. 1;

FIG. 6 is a flow chart of method steps wherein the parking meter health or operational status report of FIG. 5 is used to substantiate a parking citation; and

FIG. 7 is a schematic block diagram of a general purpose computer upon which arrangements described can be practiced.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Some portions of the description which follows are explicitly or implicitly presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “scanning”, “calculating”, “determining”, “replacing”, “generating” “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not necessarily inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also discloses a computer readable medium comprising a computer program for performing the operations of the methods. The computer readable medium is taken herein to include any transmission medium for communicating the computer program between a source and a designation. The transmission medium may include storage devices such as magnetic or optical disks, memory chips, flash memory or other storage devices suitable for interfacing with a general purpose computer. The transmission medium may also include infra red or a hard-wired medium such as exemplified in the Internet system, or wireless medium such as exemplified in the GSM mobile telephone system. The computer program is not intended to be limited to any particular programming language and implementation thereof. It will be appreciated that a variety of programming languages and coding thereof may be used to implement the teachings of the disclosure contained herein.

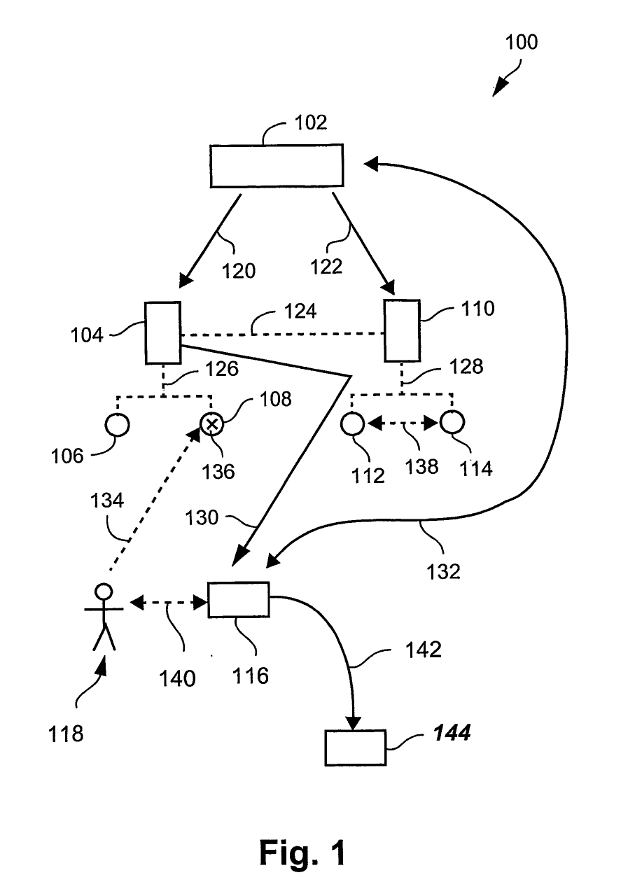

FIG. 1 depicts a system block diagram representation of one arrangement of a parking meter enforcement system. A number of parking meters 104, . . . , 110 constitute a parking meter group, as denoted by a dashed line 124. Each of the aforementioned parking meters, for example 110, may control a single space, or in the context of MultiBay meters, controls a set of N parking bays denoted by reference numerals 112, . . . , 114, the set being depicted by a dashed bi-lateral arrow 138. For ease of reference, the present description covers MultiBay equipment, but could equally provide the required data for other meter types. A central system 102 performs administrative and other functions for the parking meter group 124, including storage of contextual data for each parking meter 104, . . . , 110. This contextual data relates to fixed information associated with each parking meter, such as a street address at which the parking meter is located, details of the nearest cross street intersection, applicable legislative conditions for the parking meter (such as the maximum parking period which might apply on a per-parking meter basis), and so on. The association between the central system 102 and the parking meters 104, . . . , 110 is depicted by arrows 120 and 122.

In operation, an enforcement officer 118 uses, as a tool of his or her trade, a portable enforcement terminal 116. Typically, the enforcement officer 118 establishes a communication connection 132 between the enforcement terminal 116 and the central system 102, between shifts of duty. This enables the central system to download the aforementioned contextual data to the enforcement terminal 116. Communication between the terminal 116 and the central system 102 is typically established by various means which may include docking the terminal 116 in a docking station (not shown) provided for the purpose and communicating with the central system 102, or alternately using a radio connection, cellular mobile connection or any other communication technology as may be appropriate to establish communication between the terminal 116 and the central system 102. It is accordingly clear that the connection 132 can also be established by means of an optical connection or another equivalent connection or communication means.

Once the aforementioned data has been downloaded from the central system 102 to the enforcement terminal 116, this taking place, for example, at the beginning of the day or at the beginning of a work shift, the enforcement officer 118 takes the terminal 116 to the area of operation for the day. Upon arriving at the designated geographic area, the enforcement officer 118 approaches a particular parking meter 104 and establishes communication 130 between the parking meter 104 and the terminal 116. The connection 130 between the terminal 116 and the parking meter 104 can be established by plugging the terminal 116 into a corresponding socket (not shown) in the parking meter 104, or alternately, by establishing a wireless or infra-red or other equivalent link between the terminal 116 and the parking meter 104.

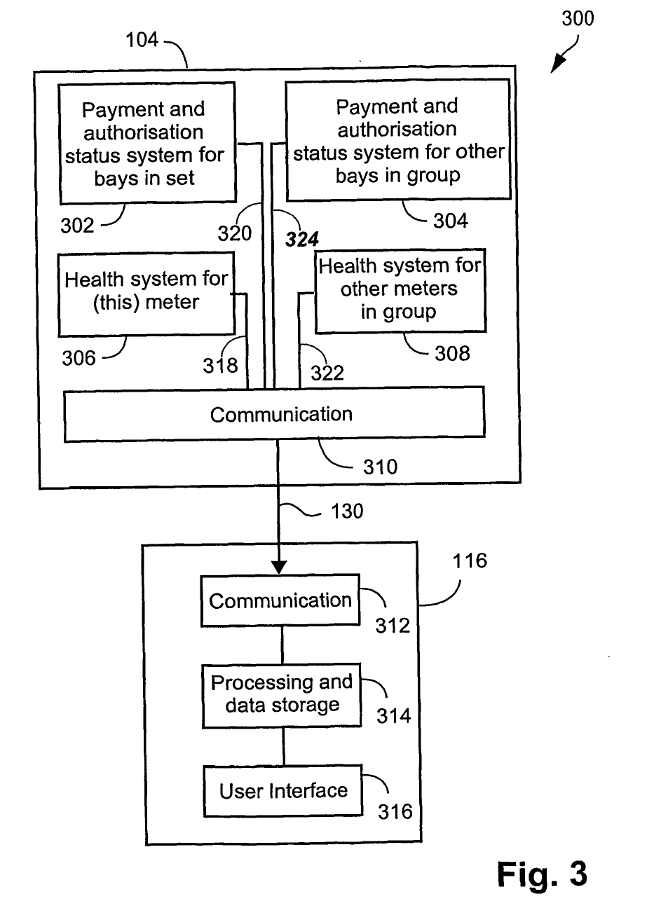

While the connection 130 is established, the parking meter 104 downloads parking status data and health or operational status status data for either a single meter being interrogated, or for the meter group 124. The group 124 may be provided with meter to meter communications, such that each meter in the group 124 stores all the contextual and parking information for the group. The group 124 may, alternately or in addition, be provided with individual or group communications to the central system 102 parking computer. The various types of information downloaded will be described in more detail with respect to FIG. 3.

Once the required information has been downloaded from the parking meter 104 to the terminal 116, the enforcement officer 118 proceeds to physically inspect the various parking bays 106, . . . , 108 and 112, . . . , 114 of the meter group 124. In a particular instance, the enforcement officer 118 inspects a particular vehicle, denoted by an “X” having a reference numeral 136, which is parked in the parking spot 108, the action of inspection being depicted by a dashed arrow 134. The officer 118 is able to establish whether the vehicle 136 is parked legally or not by interacting, as depicted by a dashed arrow 140, with the terminal 116. In simple terms, the officer 118 is able to interrogate the terminal 116 in order to establish whether the vehicle 136 is parked during a legally purchased time period, or in contrast, whether the vehicle has overstayed the paid period, or moved into a penalty period, or the driver has failed to pay for parking.

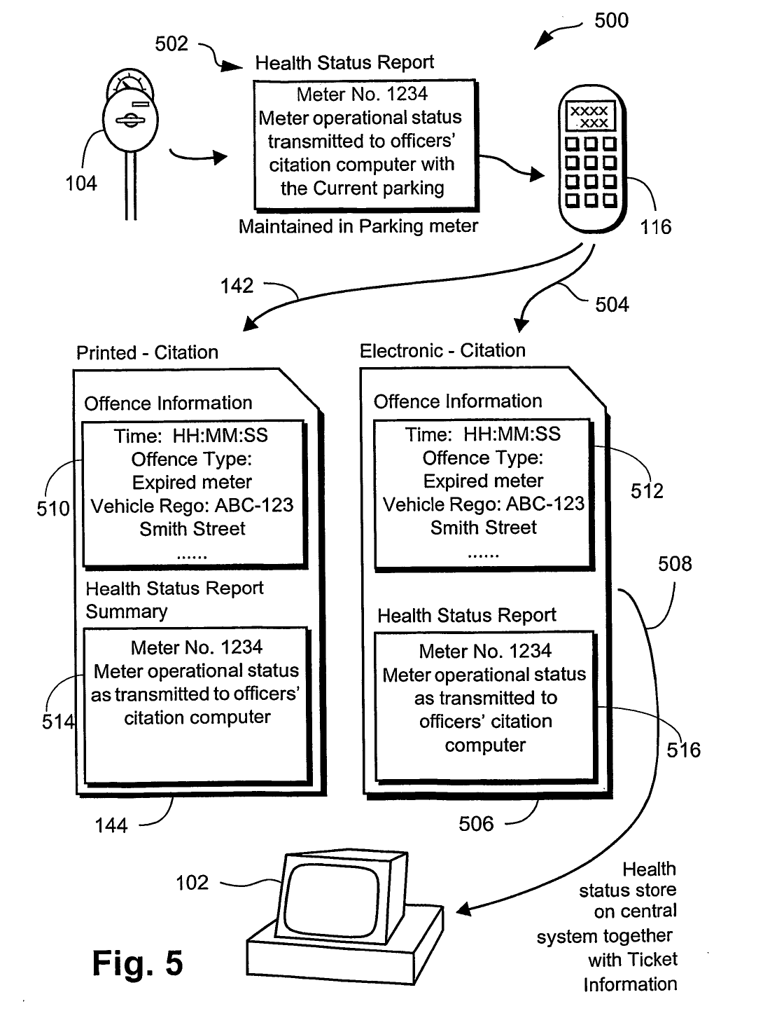

If the officer 118 determines that the vehicle 136 is, indeed, illegally parked, then the officer is able to issue, as indicated by an arrow 142, an on-the-spot citation 144 which contains details of the parking violation. The details contained in the citation 144 will be described in more detail with reference to FIG. 5. In order to produce the citation 144, the officer 118 makes use of the contextual information for the particular parking meter 104 which was downloaded into the terminal 116 prior to the beginning of the work shift from the central system 102. The officer 118 also makes use of the parking meter status for the space 108 which was downloaded from the parking meter 104 when the communication 130 was established between the terminal 116 and the parking meter 104. The parking status data indicates when the paid period expired, and also indicates a current time, thereby establishing an amount of time during which the vehicle 136 has overstayed the paid-for period. Alternately, by indicating the amount of time negatively, the parking status data can show how long it has been since any payment was received relevant to the parking space in which vehicle 136 is currently parked.

In addition to the above contextual and meter status information, the officer 118 manually enters, as depicted by a dashed arrow 140, information relating to the vehicle 136 as well as required manual entry information such as the officers' badge number or other data that acts as an electronic signature that all information is true and correct. Information about the vehicle would typically include the registration number of the vehicle, and could also include information such as the vehicle make, colour and year of manufacture. The local statutes determine the actual information required relative to the parked vehicle. Once all the aforementioned information has been input by the officer 118 into the terminal 116, the citation 144 can be produced, and it is typically then placed on the vehicle under the windscreen wiper for the motorist to find upon their return to the vehicle 136. Actual placement of the citation may vary from jurisdiction to jurisdiction.

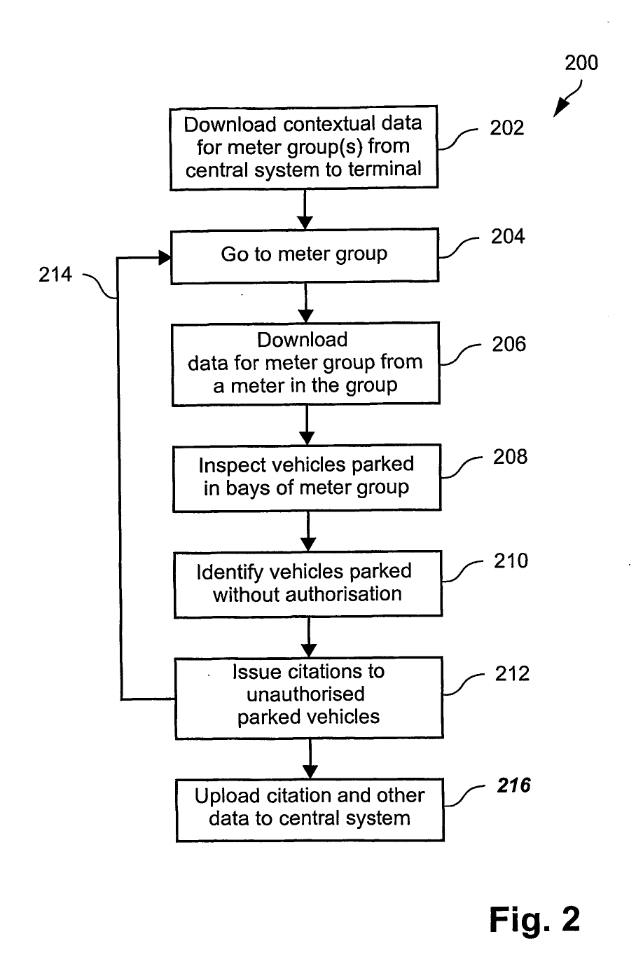

FIG. 2 shows a flow chart of steps taken by the enforcement officer 118 in the context of the system of FIG. 1. In a first step 202, the system downloads contextual data for relevant meter groups from the central system 102 to the portable terminal 116. Thereafter, in a step 204, the officer 118 makes his, or her way to the location in which the meter group is situated. Thereafter, in a step 206, the officer 118 establishes a communication between the terminal 116 and one of the parking meters in the meter group 124. The communication may be between one meter in the group and the officer's terminal 116, or if the group of meters establish group communication, the download may constitute data for the entire meter group, this being received from the meter with which the connection 130 has been established. It is noted that the communication 130 can generally be established with any meter individually, or when there is communication between meters in the meter group, a single communication may provide a download of information for the entire group. Dependent upon the communication medium, the officer 118 may not need to interrogate a meter for the aforementioned information, but may instead receive it via a radio or other broadcast method directly to the terminal 116. Furthermore, it is possible to download data for more than one meter group while the communication 130 is established.

Returning to FIG. 2, in a following step 208, the officer 118 inspects all vehicles parked in bays of the meter group under consideration. In the course of that inspection, the officer 118 identifies vehicles which are parked without authorisation, or payment, or sufficient payment for the time the vehicle has been parked, as depicted in a step 210. Thereafter, in a step 212, the officer 118 issues citations for vehicles which are illegally parked.

If the officer 118 has not yet completed their work day, the officer proceeds to the next meter group as depicted by an arrow 214. Alternatively, if the officer 118 has completed his or her workday shift, the officer can return to the location where the central system 102 is located, establish the communication 132 as shown in FIG. 1, and upload citation and other data including operational status data of each meter to the central system 102 as shown in a step 216.

FIG. 3 shows functional sub-systems within the parking meter 104, and within the portable terminal 116 shown in FIG. 1. The parking meter 104 is seen to contain a number of functional sub-systems, a first sub-system 302 being concerned with issues of payment and authorisation status for the parking bays 106 to 108 in the set of parking bays associated with the parking meter 104. Accordingly, this sub-system 302 monitors and correlates payment provided by motorists in respect of the parking bays 106 to 108, and provides this information to the officer 118 when a download connection 130 is established. A sub-system 306 is concerned with a different aspect of the parking meter 104. This sub-system 306 monitors the health or operational status of the meter 104 and stores health or operational status information for the meter in an internal memory (not shown). The term “health or operational status” when applied to the parking meter 104 extends to operational status of the meter 104 as well as other events such as opening of access panels and so on.

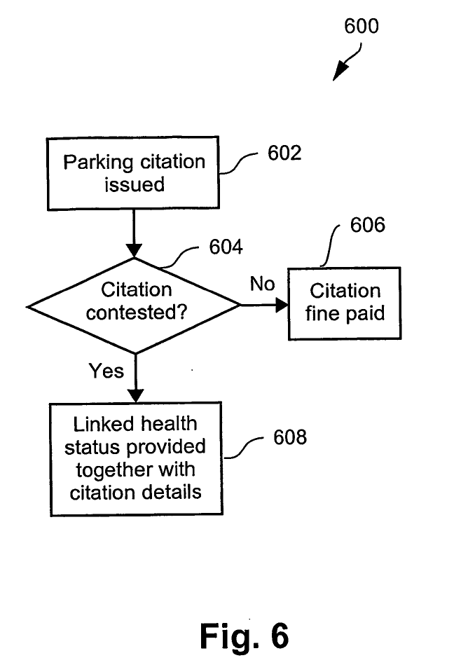

In a first arrangement, the sub-system 306 is concerned with establishing a time-stamped record of the health or operational status of the meter 104, so that the operational health or operational status of the meter 104 at a particular time can be easily established. This first arrangement is used for establishing a meter performance and health or operational status history, which can be used for establishing service and maintenance schedules for preventive and remedial maintenance of the parking meter system. In a second arrangement, the sub-system 306 is concerned with providing a health or operational status record for the parking meter 104, for the specific purpose of providing a simple and rapid source of information by which a citation can be substantiated in regard to the health or operational status of the meter 104 when the citation was issued and for a relevant prior period. A rationale for the second arrangement is provided in more detail in relation to FIG. 6. The aforementioned sub-systems 302 and 306 may be connected to a communication sub-system 310 as depicted by connections 320 and 318 respectively.

The aforementioned sub-systems 302 and 306 relate to the parking meter 104 itself. In contrast, a sub-system 304 deals with payment and authorisation status for other parking bays in the meter group 124. This arrangement requires that the parking meter 104 downloads information from other meters in the meter group 124. This information can be obtained, for example, by means of a communication network connecting the various meters in the meter group 124. This allows the officer to get a breakdown of the number of vehicles in an area for which parking time has expired. This allows for more efficient enforcement of the parking regulations. The officer is able to access information from a single meter in the group, and thereby obtain all the information for all the vehicles parked at all the meters in a street or in an area controlled by meters that are communicating relevant information to each other. Thereafter, the officer can go directly to the expired vehicles and exercise the duty placed upon him.

Accordingly, the sub-system 304 deals with the same type of information as the sub-system 302, however the sub-system 304 is concerned with other parking meters in the meter group 124. A sub-system 308 is concerned with health or operational status of other meters in the meter group 124, in contrast to the sub-system 306 which is concerned with health or operational status of the present parking meter 104. The sub-systems 304 and 308 are connected to the communication sub-system 310 by means of connections 324 and 322 respectively.

The portable enforcement terminal 116 contains a number of sub-systems 312, 314 and 316 which depict a communication sub-system, a processing and data storage sub-system, and a user interface respectively. When the enforcement officer 118 establishes the communication 130 between the terminal 116 and the parking meter 104, as depicted by the arrow 130, the parking meter 104 is able to transfer information from the various sub-systems 302 to 308, by means of the connection 130 to the terminal 116.

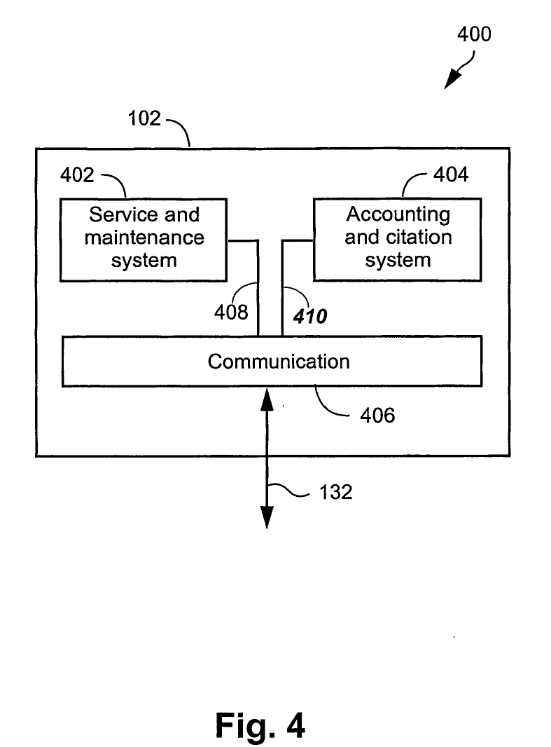

FIG. 4 shows sub-system blocks within the central system 102 shown in FIG. 1. The central system 102 is seen to have at least three sub-systems 402 to 406. The sub-system 402 is a service and maintenance system which typically comprises a computer and associated storage devices and other peripherals. This service and maintenance system 402 is concerned with maintaining and organising data for the various parking meter groups (for example the group 124) within the scope of control exercised by the central system 102. Information contained in the system 402 would include, but not be limited to, performance data for the parking meters including Mean Time Between Failure (MTBF) for each meter, types of faults recorded for each meter, times and duration of full operational health or operational status, and so on. Additional information might include times of service technician visits, expenses incurred for repairs and so on. The service and maintenance system 402 contains a large amount of data for the purposes of statistical analysis of system performance in order to establish, for example, system wide maintenance schedules. Accordingly, the database associated with the service and maintenance system 402 stores a great deal of data which is not required in order to substantiate a citation.

The sub-system 404 is concerned with accounting and citation information. Accordingly, this system 404 contains, in the form of an electronic citation file on a per citation basis, contextual and status information relating to each issued citation, for example the citation 144 in FIG. 1, including health or operational status data as will be explained in more detail with reference to FIG. 5. Furthermore, each citation file contains the information manually entered by the officer 118 for the citation 144 such as the make and registration number of a vehicle 136 which was illegally parked in a space 108, details about the infringement and substantiation thereof as required by relevant statutes, plus any comments the officer thought pertinent at the time. The arrangement and organisation of data in the accounting and citation system 404 makes it particularly simple to access health or operational status information to support, and substantiate, any particular citation which is contested. This ease of data arrangement and access provides a particular advantage when dealing with a motorist contesting a citation. This will be explained in more detail with reference to FIG. 6.

The service and maintenance system 402 and the accounting and citation system 404 are connected by respective connections 408 and 410 to a communication sub-system 406 which is capable, by means of a connection 132, of exchanging information with the terminal 116 (see FIG. 1).

FIG. 5 shows an exemplary health or operational status report 502, and a citation 144 as would typically be issued in the system of FIG. 1. When the enforcement officer 118 (see FIG. 1) establishes the communication depicted by the arrow 130 between the parking meter 104 and the portable terminal 116, part of the meter group status information which is downloaded from the parking meter 104 to the terminal 116 is the health or operational status report 502 for the parking meter 104. This report 502 is provided by the meter health or operational status sub-system 306 as described in relation to FIG. 3.

As noted, the health or operational status sub-system 306 in the meter 104 is capable of operating in two alternative ways. In the first arrangement the health or operational status sub-system can download a historic health or operational status record for the meter covering a historic period of some predetermined length. This type of record can take the form of a number of historic records, information on when the last fault was recorded, information on when the last service was recorded and so on. This type of record is useful for incorporation into the maintenance and service central sub-system 402. In the second arrangement, the health or operational status sub-system 306 can download a health or operational status snapshot at the time that the enforcement officer conducts the download 130 from the parking meter 104. In this case, it is the health or operational status of the meter for a period prior to the citation being issued which is of interest, rather than long term historic health or operational status data. In the second arrangement, the meter can download a health or operational status report for the meter which extends backwards in time, for example, from the time at which the download during the connection 130 occurs, back to the last time when money was inserted into the parking meter in question. It is noted that the health or operational status report in this case takes account of the fact that the meter may have become faulty during the period in question. Under these circumstances, the meter fault diagnostic system would determine that a fault has taken place and log it accordingly, after which a repair/service call would have been made. This information can also be provided in the operational status report that is filed at the end of each shift, when the officer's citation computer downloads the shift data to the computer 102 via the connection 132. Typically, this report is forwarded to a maintenance section for attention.

The printed citation 144 produced by the terminal 116 has, typically, information as shown in the representation 144 in FIG. 5. When the citation 144 is issued by the officer 118 using the terminal 116, an electronic copy 506 of the citation is also produced by the terminal 116, as depicted by an arrow 504, and is stored in the terminal 116 when the citation 144 is issued. At a later stage, when the officer 118 establishes the communication 132 between the terminal 116 and the central system 102 (see FIG. 1), then the electronic copy 506 of the citation is communicated, as depicted by an arrow 508, to the central system 102. In particular, the electronic copy of the citation 506 is stored in the accounting and citation sub-system 404 (see FIG. 4). Accordingly, as can be seen from both the printed citation 144 and the electronic copy thereof 506, citation details 510 and 512 are incorporated together in a common data structure with their associated health or operational status reports 514 and 516 respectively, noting that the health or operational status reports are provided substantially at the time that the citation is issued, and not extracted from stored historic health or operational status data at a later time.

FIG. 6 shows a flow chart of method steps wherein the parking meter health or operational status report 502 of FIG. 5 is used to substantiate a contested parking citation. In a first step 602 the enforcement officer 118 issues a parking citation in paper form (see 144 in FIG. 5) to the motorist. In a next step 604, the “contested status” of the citation is tested, and in the event that the citation is not contested, then the process 600 is directed in accordance with a “no” arrow to the step 606 in which the motorist pays the fine associated with the citation, and the process 600 terminates. If, however, at the step 604, the motorist does contest the citation, then the process 600 is directed in accordance with a “yes” arrow to a step 608. The step 608 pictorially represents a process in which the motorist contesting the citation puts his or her case, typically to a magistrate in a local court. In traditional systems, if the motorist maintains that the parking meter 104 was inoperative at the time when he or she arrived at the parking meter and attempted to pay the necessary parking charge, it would be necessary for the magistrate to call a number of witnesses to establish the facts. These witnesses would include the enforcement officer 118, and it would be necessary for the court to decide whether the motorist was telling the truth or not.

In accordance with one arrangement described in the present specification, the motorist has been issued with a printed citation 144 having printed thereon a copy of the meter health or operational status report 514 (see FIG. 5). In this event, it is difficult for the motorist to allege that the parking meter 104 was inoperative at the time when the citation was issued.

In another arrangement, the health or operational status report 514 is not directly printed on the citation 144. In this case, the judge in the local court is able to directly access the electronic citation file 506 by means of a terminal in the court. Alternately, the judge can obtain a relevant printout from the accounting and citation system 404 (see FIG. 4). The aforementioned printout constitutes physical evidence for use by the court, and can be used to create a profile for the meter in question. Therefore, various options are available for accessing the associated health or operational status report 516 which has been stored together with the electronic copy of the citation 506 in the accounting and citation sub-system 404 of the central system 102.

The technique of storing the health or operational status report 516 for a citation 506 directly with the electronic file 506 associated with the citation 144 allows for a significant reduction in operational complexity, and in the processing time needed to retrieve health or operational status details for the parking meter 104 relating to the particular citation 144 in question. The historic health or operational status and operational status for parking meters which is stored in the service and maintenance sub-system 402 need not be accessed for this purpose, and instead the specific health or operational status report 516 for each citation 506 is stored directly with the electronic file for the citation 506 in the accounting and citation sub-system 404. This makes for particularly easy and rapid retrieval of information in the event that a court officer is required to do so by means of a terminal.

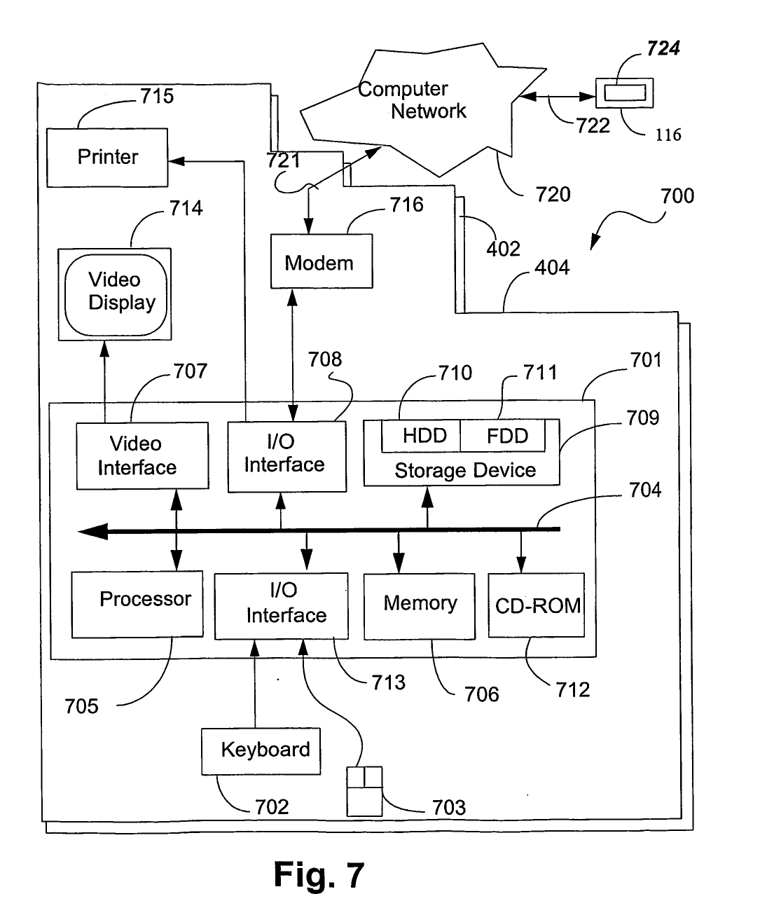

The method of issuing a parking citation can be practiced using a computer system 700, to implement the Accounting and Citation System 404, which operates in conjunction with a special purpose computer system 724 in the terminal 116, as shown in FIG. 7 wherein at least some of the processes of FIGS. 2 and 6 may be implemented as software, such as an application program executing within the computer system 700. The application program can comprise one or more program elements suitably distributed between the accounting and citation system 404 and the special purpose computer system 724. The special purpose computer system 724 in the terminal 116 includes the communication, processing and data storage, and user interface sub-systems 312-316 respectively as described in relation to FIG. 3. The Service and Maintenance sub-system 402 is also shown in FIG. 7 for completeness. In particular, the steps of the method of issuing a parking citation are effected by instructions in the software that are carried out by the computers 404 and 724. The instructions may be formed as one or more code modules, each for performing one or more particular tasks. The software may also be divided into two separate parts, in which a first part performs the issuing a parking citation methods, and a second part manages a user interface between the first part and the user. The software may be stored in a computer readable medium, including the storage devices described below, for example. The software is loaded into the computers from the computer readable medium, and then executed by the computers. A computer readable medium having such software or computer program recorded on it is a computer program product. The use of the computer program product in the computers preferably effects an advantageous apparatus for issuing a parking citation.

The computer system 404 comprises a computer module 701, input devices such as a keyboard 702 and mouse 703, output devices including a printer 715 and a display device 714. A Modulator-Demodulator (Modem) transceiver device 716 is used by the computer module 701 for communicating to and from a communications network 720, for example connectable via a telephone line 721 or other functional medium. The modem 716 can be used to obtain access to the enforcement terminal 116, the Internet, and other network systems, such as a Local Area Network (LAN) or a Wide Area Network (WAN).

The enforcement terminal 116 communicates, using a connection 722 to the network 720, and thereafter, with the computer systems 402 and 404.

The computer module 701 typically includes at least one processor unit 705, a memory unit 706, for example formed from semiconductor random access memory (RAM) and read only memory (ROM), input/output (I/O) interfaces including a video interface 707, and an I/O interface 713 for the keyboard 702 and mouse 703 and optionally a joystick (not illustrated), and an interface 708 for the modem 716. A storage device 709 is provided and typically includes a hard disk drive 710 and a floppy disk drive 711. A magnetic tape drive (not illustrated) may also be used. A CD-ROM drive 712 is typically provided as a non-volatile source of data. The components 705 to 713 of the computer module 701, typically communicate via an interconnected bus 704 and in a manner which results in a conventional mode of operation of the computer system 700 known to those in the relevant art. Examples of computers on which the described arrangements can be practised include IBM-PC's and compatibles, Apple systems, Sun Sparcstations or alike computer systems evolved therefrom.

Typically, the application program for the citation system 404 is resident on the hard disk drive 710 and read and controlled in its execution by the processor 705. Intermediate storage of the program and any data fetched from the network 720 may be accomplished using the semiconductor memory 706, possibly in concert with the hard disk drive 710. In some instances, the application program may be supplied to the user encoded on a CD-ROM or floppy disk and read via the corresponding drive 712 or 711, or alternatively may be read by the user from the network 720 via the modem device 716. Still further, the software can also be loaded into the computer system 700 from other computer readable media. The term “computer readable medium” as used herein refers to any storage or transmission medium that participates in providing instructions and/or data to the computer system 700 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 701. Examples of transmission media include radio or infra-red transmission channels as well as a network connection to another computer or networked device, and the Internet or Intranets including email transmissions and information recorded on websites and the like.

The method of issuing a parking citation may alternatively be implemented in dedicated hardware such as one or more integrated circuits performing the functions or sub functions of issuing a parking citation. Such dedicated hardware may include graphic processors, digital signal processors, or one or more microprocessors and associated memories.

### Industrial Applicability

It is apparent from the above that the arrangements described are applicable to the parking meter industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including” and not “consisting only of”. Variations of the word comprising, such as “comprise” and “comprises” have corresponding meanings.

1. A method of issuing a parking citation against a vehicle that has been parked during a first time period in a parking space associated with a parking meter, said method comprising the steps of:
determining parking citation data for the vehicle;
automatically ascertaining an operational status for the parking meter during a second time period; and
issuing, depending upon the citation data and the operational status, the citation including the parking citation data and the operational status.

2. A method according to claim 1, wherein the step of determining parking citation data for the vehicle includes the steps of:
establishing a communications link between a portable enforcement terminal and a central system to thereby down-load contextual data for the parking meter from the central system to the terminal; and
establishing a communications link between the portable enforcement terminal and the parking meter to thereby down-load parking status data for the vehicle from the parking meter to the terminal.

3. A method according to claim 2, comprising a further step of manually entering data into the portable enforcement terminal.

4. A method according to claim 1, wherein the step of ascertaining the operational status for the parking meter comprises establishing a communications link between the portable enforcement terminal and the parking meter to thereby down-load the operational status from the parking meter to the terminal.

5. A method according to claim 1, wherein after determining the citation data and prior to issuing the citation, said method comprises the further steps of:
establishing, depending upon the parking citation data, whether the vehicle has violated parking regulations; and
establishing, depending upon the operational status, whether the parking meter was operative during the first time period.

6. A method according to claim 1, wherein the parking citation data is dependent upon the parking status for the vehicle, identification data for the vehicle, and contextual data for the parking meter.

7. A method according to claim 1, wherein the operational status is dependent upon at least one of health of the parking meter and status of access panels of the parking meter.

8. A method according to claim 1, wherein said second time period is the same as the first time period.

9. A method according to claim 1, wherein said second time period extends from the time when the citation is being prepared backwards in time to a time when a previous payment was made.

10. A method according to claim 1, wherein the citation data and the operational status are established when the citation is issued.

11. A method according to claim 1, wherein the second time period is the time during which the citation is being prepared.

12. A method of issuing a parking citation against a vehicle that has been parked during a first time period in a parking space associated with a parking meter, said method comprising the steps of:
determining parking citation data for the vehicle;
automatically ascertaining an operational status for the parking meter during a second time period;
issuing, depending upon the citation data and the operational status, the citation including the parking citation data; and
storing an associated electronic citation file comprising the parking citation data and the operational status.

13. A method as claimed in claim 12, comprising the further step of:
if the citation is contested, retrieving the associated electronic citation file as evidence that the parking meter was operative during the first time period.

14. A method according to claim 12, wherein the step of determining parking citation data for the vehicle includes the steps of:
establishing a communications link between a portable enforcement terminal and a central system to thereby down-load contextual data for the parking meter from the central system to the terminal; and
establishing a communications link between the portable enforcement terminal and the parking meter to thereby down-load parking status data for the vehicle from the parking meter to the terminal.

15. A method according to claim 14, comprising a further step of manually entering data into the portable enforcement terminal.

16. A method according to claim 12, wherein the step of ascertaining the operational status for the parking meter comprises establishing a communications link between the portable enforcement terminal and the parking meter to thereby down-load the operational status from the parking meter to the terminal.

17. A method according to claim 12, wherein after determining the citation data and prior to issuing the citation, said method comprises the further steps of:
establishing, depending upon the parking citation data, whether the vehicle has violated parking regulations; and
establishing, depending upon the operational status, whether the parking meter was operative during the first time period.

18. A method according to claim 12, wherein the parking citation data is dependent upon the parking status for the vehicle, identification data for the vehicle, and contextual data for the parking meter.

19. A method according to claim 12, wherein the operational status is dependent upon at least one of health of the parking meter and status of access panels of the parking meter.

20. A method according to claim 12, wherein the second time period is the same as the first time period.

21. A method according to claim 12, wherein said second time period extends from the time when the citation is being prepared backwards in time to a time when a previous payment was made.

22. A method according to claim 12, wherein the second time period is the time during which the citation is being prepared.

23. A method according to claim 12, wherein the parking citation data and the operational status are established when the citation is issued.

24. A parking meter system adapted for issuing a parking citation against a vehicle that has been parked during a first time period in a parking space associated with a parking meter, said system comprising:
means for establishing parking citation data for the vehicle;
means for automatically ascertaining an operational status for the parking meter during a second time period; and
means for issuing, depending upon the citation data and the operational status, the citation, said citation including the parking citation data and the operational status.

25. A system according to claim 24, further comprising:
a central system;
a portable enforcement terminal;
means for establishing a communications link between the portable enforcement terminal and the central system to thereby down-load contextual data for the parking meter from the central system to the terminal; and
means for establishing a communications link between the portable enforcement terminal and the parking meter to thereby down-load parking status data for the vehicle.

26. A system according to claim 25, the terminal further comprising means for manually entering data into the portable enforcement terminal.

27. A system according to claim 25, further comprising means for establishing a communications link between the portable enforcement terminal and the parking meter to thereby down-load the operational status for the parking meter.

28. A system according to claim 25, further comprising:
means for establishing, depending upon the parking citation data, whether the vehicle has violated parking regulations; and
means for establishing, depending upon the operational status, whether the parking meter was operative during the first time period.

29. A parking meter system according to claim 24, wherein the parking citation data is dependent upon a parking status for the vehicle, identification data for the vehicle, and contextual data for the parking meter.

30. A system according to claim 24, wherein the operational status is dependent upon at least one of health of the parking meter and status of access panels of the parking meter.

31. A system according to claim 24, wherein said second time period is the same as the first time period.

32. A system according to claim 24, wherein said second time period extends from the time when the citation is being prepared backwards in time to a time when a previous payment was made.

33. A system according to claim 24, wherein the citation data and the operational status are established when the citation is issued.

34. A system according to claim 24, wherein the parking citation data and the operational status are established when the citation is issued.

35. A parking meter system adapted for issuing a parking citation against a vehicle that has been parked during a first time period in a parking space associated with a parking meter, said system comprising:
means for determining parking citation data for the vehicle;
means for automatically ascertaining an operational status for the parking meter during a second time period;
means for issuing, depending upon the citation data and the operational status, the citation, comprising the parking citation data; and
means for storing an associated electronic citation file comprising the parking citation data and the operational status, said electronic citation file serving as evidence that the parking meter was operative during the first time period.

36. A parking meter system according to claim 35, wherein the parking citation data is dependent upon a parking status for the vehicle, identification data for the vehicle, and contextual data for the parking meter.

37. A system according to claim 35, wherein the operational status is dependent upon at least one of health of the parking meter and status of access panels of the parking meter.

38. A system according to claim 35, wherein said second time period is the same as the first time period.

39. A system according to claim 35, wherein said second time period extends from the time when the citation is being prepared backwards in time to a time when a previous payment was made.

40. A system according to claim 35, wherein the parking citation data and the operational status are established when the citation is issued.

41. A parking citation for a vehicle parked during a first time period in a parking space associated with a parking meter, said citation comprising:
parking citation data for the vehicle; and
an automatically derived operational status for the parking meter during a time period in which a payment in respect of the first period could have been made, the operational status on the citation establishing whether the parking meter was operative during the first time period.

42. A parking citation according to claim 41, wherein said citation is at least one of:
a citation in paper form that is served on the vehicle when a citation status of the vehicle is determined; and
a citation in electronically storage form, said citation being stored for use if said citation is contested.

43. A parking citation according to claim 42, wherein the parking citation data and the operational status are established when the citation is served.

44. A computer program comprising at least one program element, said at least one computer program element comprising computer program code means to make at least one computer execute a procedure to perform at least one of issuing and substantiating a parking meter citation, said at least one computer program element comprising:
code for a determining step for determining parking citation data for the vehicle;
code for an ascertaining step for automatically ascertaining an operational status for the parking meter during a second time period; and
code for an issuing step for issuing, depending upon the citation data and the operational status, a citation including the parking citation data and the operational status.

45. A computer program according to claim 44, wherein the code for determining parking citation data for the vehicle includes:
code for establishing a communications link between a portable enforcement terminal and a central system to thereby down-load contextual data for the parking meter from the central system to the terminal; and
code for establishing a communications link between the portable enforcement terminal and the parking meter to thereby down-load parking status data for the vehicle from the parking meter to the terminal.

46. A computer program according to claim 45, wherein the code for ascertaining the operational status for the parking meter comprises code for establishing a communications link between the portable enforcement terminal and the parking meter to thereby down-load the operational status for the parking meter.

47. A computer program according to claim 44, further comprising:
code for establishing, depending upon the parking citation data, whether the vehicle has violated parking regulations; and
code for establishing, depending upon the operational status, whether the parking meter was operative during the first time period.

48. A computer program according to claim 44, wherein the parking citation data is dependent upon at least one of the parking status for the vehicle, identification data for the vehicle, and contextual data for the parking meter.

49. A computer program according to claim 44, wherein the operational status is dependent upon at least one of health of the parking meter and status of access panels of the parking meter.

50. A computer program according to claim 44, wherein said second time period is the same as the first time period.

51. A computer program according to claim 44, wherein said second time period extends from the time when the citation is being prepared backwards in time to a time when a previous payment was made.

52. A computer program according to claim 44, wherein the citation data and the operational status are established when the citation is issued.

53. A computer program according to claim 44, wherein the second time period is the time during which the citation is being prepared.

54. A computer program comprising at least one program element, said at least one computer program element comprising computer program code means to make at least one computer execute a procedure to perform at least one of issuing and substantiating a parking meter citation, said at least one computer program element comprising:
code for a determining step for determining parking citation data for the vehicle;
code for an ascertaining step for automatically ascertaining an operational status for the parking meter during a second time period;
code for an issuing step for issuing, depending upon the citation data and the operational status, the citation, comprising the parking citation data; and
code for a storing step for storing an associated electronic citation file comprising the parking citation data and the operational status.

55. A computer program according to claim 54, wherein the code for determining the parking citation data for the vehicle includes:
code for establishing a communications link between a portable enforcement terminal and a central system to thereby down-load contextual data for the parking meter from the central system to the terminal; and
code for establishing a communications link between the portable enforcement terminal and the parking meter to thereby down-load parking status data for the vehicle from the parking meter to the terminal.

56. A computer program according to claim 54, wherein the code for ascertaining the operational status for the parking meter comprises code for establishing a communications link between the portable enforcement terminal and the parking meter to thereby down-load the operational status from the parking meter to the terminal.

57. A computer program according to claim 54, further comprising:
code for establishing, depending upon the parking citation data, whether the vehicle has violated parking regulations; and
code for establishing, depending upon the operational status, whether the parking meter was operative during the first time period.

58. A computer readable medium, having a program recorded thereon, where the program is configured to make a computer execute a procedure to perform at least one of issuing and substantiating a parking meter citation in accordance with any one of the above methods.
